(19) United States
(12) Patent Application Publication
(10) Pub. No.: US 2014/0325568 A1
(43) Pub. Date: Oct. 30, 2014

(54) DYNAMIC CREATION OF HIGHLIGHT REEL TV SHOW

(71) Applicant: Microsoft Corporation, Redmond, WA (US)

(72) Inventors: Peter Duyen Hung Hoang, Delta (CA); David James Jurenka, Woodinville, WA (US); William Michael Mozell, North Vancouver (CA); David Seymour, Vancouver (CA); Henry Stuart Denison Watson, Vancouver (CA)

(73) Assignee: Microsoft Corporation, Redmond, WA (US)

(21) Appl. No.: 14/243,253

(22) Filed: Apr. 2, 2014

Related U.S. Application Data
(60) Provisional application No. 61/816,688, filed on Apr. 26, 2013.

(51) Int. Cl. H04N 21/262; H04N 21/235; H04N 21/435; H04N 21/2668; H04N 21/482; H04N 21/44

(52) U.S. Cl. CPC H04N 21/26258; H04N 21/4825; H04N 21/44; H04N 21/435; H04N 21/2668; H04N 21/235
USPC 725/61; 725/87

(57) ABSTRACT

A system and method are disclosed for compiling video clips into a playlist and/or for automatically customizing the playlist videos into a highlight reel. The video clips selected into the playlist may be customized for a particular user or group of users. The video clips may also be presented in the highlight reel so to emulate a polished, TV broadcast. The highlight reel may be processed to include an opening sequence, transitional sequences between videos in the highlight reel to segue between videos, and a closing sequence providing a close to the highlight reel. These features provide the look and feel of a manually produced, high quality TV broadcast, but are automatically generated in accordance with the present technology.

### PRIORITY CLAIM

This application claims priority to U.S. Provisional Patent Application No. 61/816,688, filed Apr. 26, 2013, which is incorporated herein by reference in its entirety.

### BACKGROUND

Traditional broadcast TV current events shows are compilations of short video stories edited and produced by a news room. By contrast, users who consume internet-based videos do so clip by clip, presented to a user in succession. The sequence of clip after clip does not have the “programmed” feel of a broadcast TV show and the visual pacing of the playback of each clip does not feel like a TV show.

### SUMMARY

A system is provided for customizing and automating the generation of a highlight reel of video clips. The system selects, sequences, and links the video clips in such a way that it feels like a high quality broadcast TV experience. The highlight reel may be processed to include an opening sequence, transitional sequences between videos in the highlight reel to segue between videos, and a closing sequence providing a close to the highlight reel. These features provide the look and feel of a manually produced, high quality TV broadcast, but are automatically generated in accordance with the present technology.

In an example, the present technology relates to a method of generating and presenting a video highlight reel, comprising: (a) receiving a playlist of videos and metadata associated with the videos in the playlist; (b) processing the playlist into the highlight reel by including videos from the playlist and at least one of an opening video sequence, a transitional video sequence between two videos in the playlist and a closing video sequence, the at least one opening video sequence, transitional video sequence and closing video sequence automatically and dynamically created using the metadata associated with the videos in the playlist; and (c) displaying the highlight reel.

In a further example, the present technology relates to a system for generating and presenting a customized video highlight reel, comprising: a computing device, comprising: a processor receiving a customized playlist of videos and metadata associated with the videos in the playlist, the playlist customized for a user based on at least one of the user's profile, expressed preferences and popularity of the videos, the processor processing the playlist into the highlight reel by including videos from the playlist and at least one of an opening video sequence, a transitional video sequence between two videos in the playlist and a closing video sequence, the at least one opening video sequence, transitional video sequence and closing video sequence automatically and dynamically created using the metadata associated with the videos in the playlist; and a display for displaying the highlight reel.

In another example, the present technology relates to a computer-readable storage medium for programing a processor to perform a method of generating and presenting a video highlight reel, the method comprising: (a) receiving a playlist of videos and metadata associated with the videos in the playlist, the playlist customized for a user as to selection and ordering of videos in the playlist based on at least one or the user's profile, the user's preferences and the popularity of the videos in the playlist; (b) processing the playlist into the highlight reel by including videos from the playlist and at least one of an opening video sequence, a transitional video sequence between two videos in the playlist and a closing video sequence, the at least one opening video sequence, transitional video sequence and closing video sequence automatically and dynamically created using the metadata associated with the videos in the playlist; (c) generating a video guide including titles of the videos in the highlight reel and a description of the videos in the highlight reel, the titles and descriptions generated using the metadata associated with the videos in the playlist; and (d) displaying videos from the highlight reel and a user interface including the video guide, the videos displayed in a user-defined order based on a received interaction with the video guide.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a high level block diagram of a system for implementing embodiments of the present technology.

FIG. 2 is an illustration of a system implementing aspects of the present technology.

FIG. 3 is a flowchart of the operation of an embodiment of the present technology.

FIG. 4 is a user interface for selecting video clips.

FIGS. 5-11 illustrate sample frames from a highlight reel according to embodiments of the present technology.

FIG. 12 illustrates a natural user interface system for implementing an embodiment of the present technology.

FIG. 13 depicts an example entertainment console and tracking system.

### DETAILED DESCRIPTION

A system is proposed for selecting video clips into a playlist and/or for automatically customizing the playlist videos into a highlight reel. In a first aspect, video clips selected into the playlist are customized for a particular user or group of users. A variety of factors may be used in customizing selected video clips, including for example user profiles, past user selections and most popular video clips. The video clips may also be ordered in such a way so that video clips assessed to be of greatest interest to the user or users are presented first.

In a second aspect of the present technology, video clips may be presented in the highlight reel so to emulate a polished, TV broadcast manually put together by a team including a producer, editor, etc. A highlight reel generation application may process the highlight reel to include an opening sequence having a title and introducing the video clips in the highlight reel. The highlight reel generation application may further process the highlight reel to include transitional sequences between videos in the highlight reel to segue from a current to the next video in the highlight reel and to introduce the next video. The highlight reel generation application may further process the highlight reel to include a closing sequence providing a close to the highlight reel. These features provide the look and feel of a manually produced, high quality TV broadcast, but are automatically generated by the software application in accordance with the present technology.

Embodiments of the technology described below are presented in the context of sports-related highlight reels. However, it is understood that the present technology may be used to present a compilation of video clips emulating a quality TV experience in a wide variety of other contexts, including news and current events, entertainment, shopping, sales, biographies, music videos, short stories, and other subject matter compilations.

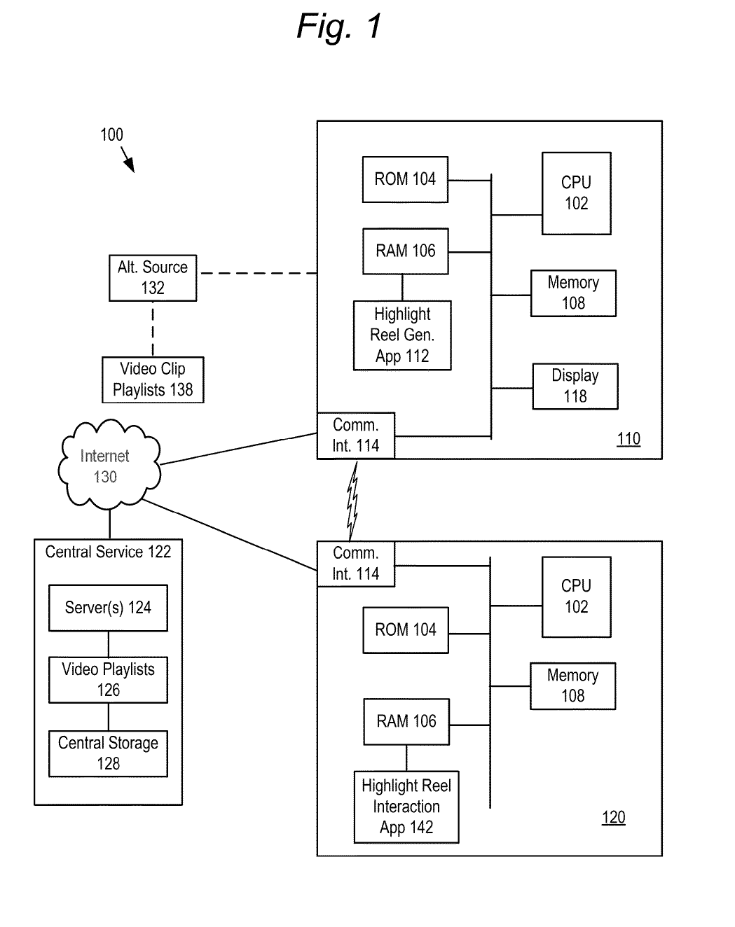

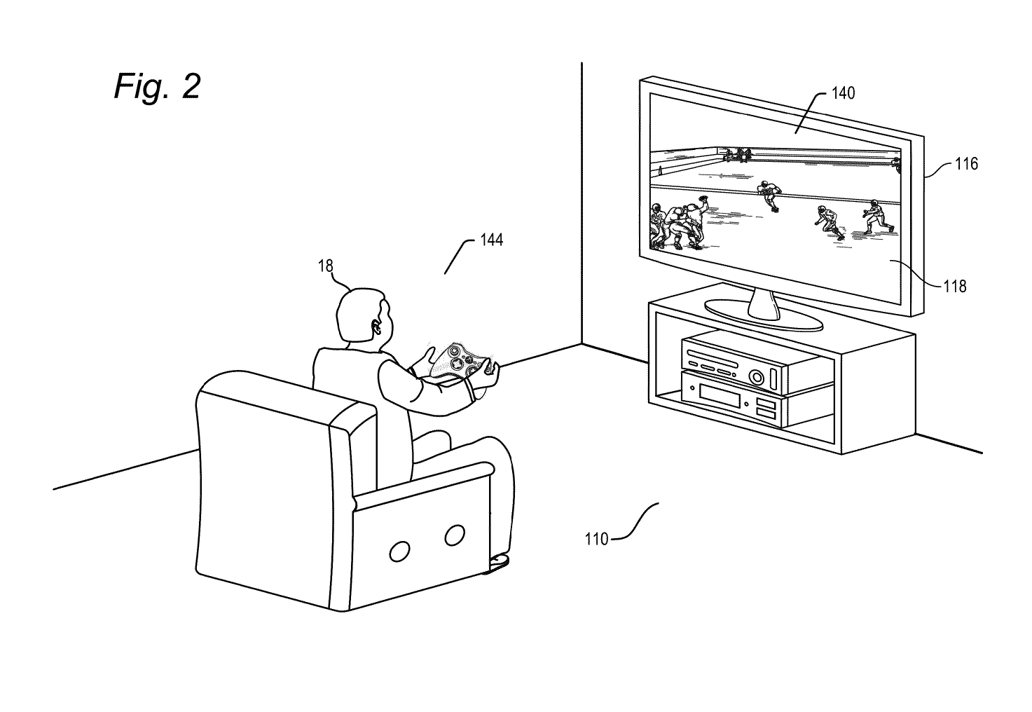

Referring to FIG. 1, there is shown a schematic block diagram of a network topology 100 for implementing embodiments of the present technology. Network topology 100 includes a first computing device 110, and an optional second computing device 120. FIG. 2 illustrates a use scenario for the first and second computing devices 110, 120. The computing device 110 (also referred to herein as client computing device 110) may be a desktop computer, media center PC, a set-top box and the like. It may be a portable computer such as a laptop, tablet or smartphone in further embodiments.

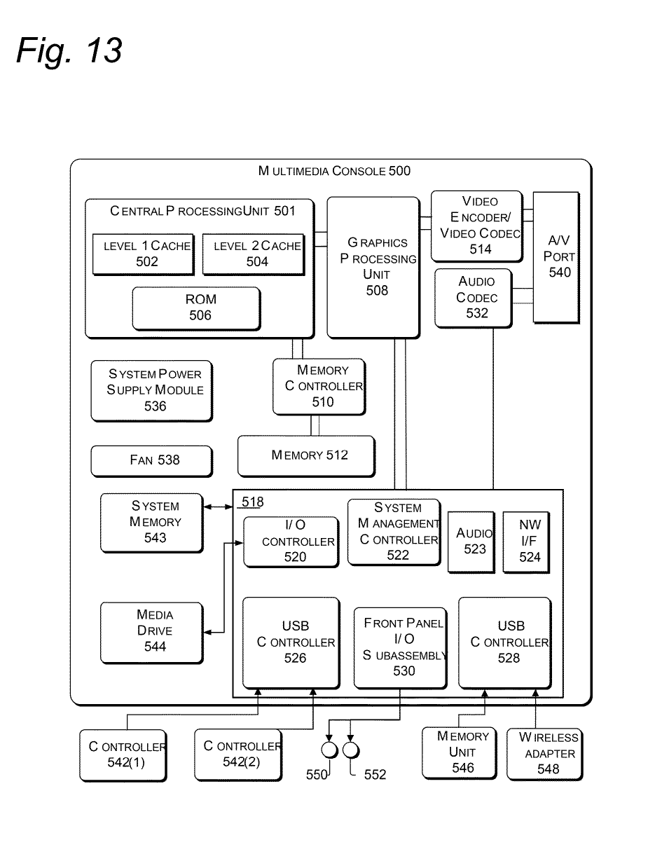

Details of an implementation of computing device 110 are provided with respect to FIG. 13 below. However, in general, computing device 110 may include a processor such as CPU 102 having access to read only memory (ROM) 104 and random access memory (RAM) 106. Computing device 110 may further include a memory 108 for storing application programs such as a highlight reel generation software application 112 for generating a highlight reel as described below. Memory 108 may further store video playlists and processed highlight reels as described below.

The computing device 110 may also include a display 118 (FIG. 1) or it may be connected to an audio/visual (A/V) device 116 having a display 118 (FIG. 2). For example, where computing device 110 is a portable device such as a laptop, the display 118 may be part of the computing device. On the other hand, where the computing device is a desktop computer or media player, the display may be separate from the computing device 110 as shown in FIG. 2. In FIG. 2, the A/V device 116 may for example be a monitor, a high-definition television (HDTV), or the like that may provide a video feed, game or application visuals and/or audio to a user 18. For example, the computing device 110 may include a video adapter such as a graphics card and/or an audio adapter such as a sound card that may provide audio/visual signals associated with recorded or downloaded video clips. In one embodiment, the audio/visual device 116 may be connected to the computing device 110 via, for example, an S-Video cable, a coaxial cable, an HDMI cable, a DVI cable, a VGA cable, a component video cable, or the like.

The highlight reel generation software application 112 may execute on CPU 102 to generate a highlight reel using video clips downloaded from a central service 122. The central service may include one or more servers 124 which compile customized playlists 126 of video clips as explained below for users of the central service 122. The playlist(s) for each user may be stored in a central storage location 128 within or associated with the central service 122. In embodiments, the central service 122 and storage location 128 may be network connected to the computing device 110 via a network connection such as the Internet 130 and a communications interface 114 within the computing device 110.

The central storage location 128 may store a separate playlist for each individual user, but it may also store a playlist for one or more groups of users. A user or group may have a single playlist of videos, or a number of playlists of videos, each playlist relating to different topics of interest to the user or group. For example, a first playlist may relate to sports, a second playlist may relate to news, a third playlist may relate to entertainment, etc.

Playlist(s) 128 may be downloaded from the central service 122 to the computing device 110 and stored in memory 108. Thereafter, the downloaded playlist(s) 128 may be processed into TV quality highlight reels by the highlight reel generation application 112 as explained below. Instead of or in addition to receiving playlists 128 from the central service 122, playlists 138 may be received from one or more alternate sources 132. These alternate sources 132 may include for example cable TV, satellite TV, terrestrial broadcast etc. Once downloaded to the computing device 110, the video clip playlist(s) 138 may be stored in memory 108 resident within computing device 110 and processed into highlight reels by the highlight reel generation application 112.

In embodiments where for example the computing device 110 is a portable device such as a laptop, a user may experience a highlight reel displayed on the computing device 110, and the user may interact with the computing device 110 to control his/her viewing experience (to for example jump ahead in the highlight reel, rewind, etc.). In a further embodiment where for example the computing device is a desktop computer or media player associated with an A/V device 116, a second computing device 120 may be provided to allow the user to interact with the computing device 110 to control his/her view experience.

The computing device 120 may be a portable computer such as a laptop, tablet, smartphone or remote control, though it may be a desktop computer in further embodiments. Details of an implementation of computing device 120 are described below with respect to FIG. 13. However, in general, computing device 120 may include a processor such as CPU 102 having access ROM 104 and RAM 106. Computing device 120 may further include a memory 108 for storing application programs such as a highlight reel interaction software application 142 for interacting with a highlight reel while being viewed as described below.

In embodiments including two computing devices such as computing devices 110 and 120, the system may be practiced in a distributed computing environment. In such embodiments, devices 110 and 120 may be linked through a communications network implemented for example by communications interfaces 114 in the computing devices 110 and 120. One such distributed computing environment may be accomplished using the Smartglass™ software application from Microsoft Corporation which allows a first computing device to act as a display, controller and/or other peripheral to a second computing device.

Thus, as illustrated in FIG. 2, the computing device 120 may provide a user interface 144 allowing a user 18 to interact with a highlight reel 140 stored on the computing device 110 and display on the A/V device 116. In a further embodiment, the computing system 110 may implement a natural user interface (NUI) system allowing a user to interact with the computing device 110 and highlight reel 140 through gestures and speech. In such an embodiment, the second computing device 120 may be omitted. In embodiments where the second computing device 120 is omitted, the highlight reel interaction software application 142 may be resident on and run from the first computing device 110.

It is understood that the functions of computing devices 110 and/or 120 may be performed by numerous other general purpose or special purpose computing system environments or configurations. Examples of other well-known computing systems, environments, and/or configurations that may be suitable for use with the system include, but are not limited to, multiprocessor systems, microprocessor-based systems, set top boxes, programmable consumer electronics, network PCs, minicomputers, distributed computing environments that include any of the above systems or devices, and the like.

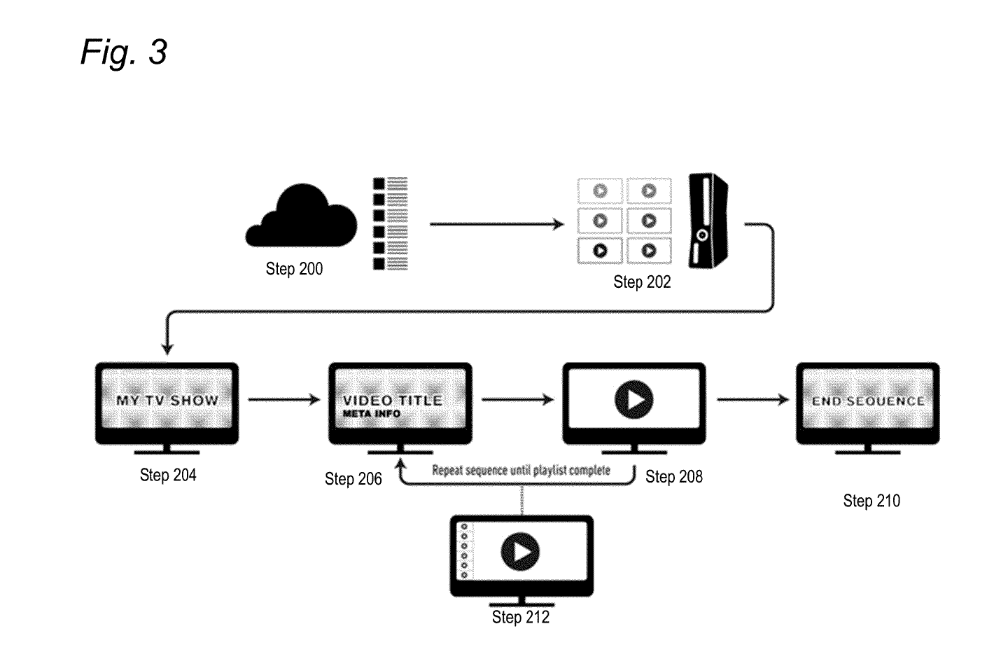

FIG. 3 illustrates a schematic flowchart of the operation of an embodiment of the present system. In step 200, a playlist 126 of videos is generated and stored in the central storage location 128 in the central service 122 as described above. The video clips compiled into a playlist 126 by server(s) 124 may be selected according to variety of selection criteria. For example, a user may specify preferences as to the type of videos which the user wants to include in his or her playlist, which preferences are stored in the central storage location 128 and used by server(s) 124. The server(s) 124 may compile playlists based on a user's stored profile. As one of many examples, the user may have stored profile information relating to a favorite sports team and playlists may be compiled showing highlights of that team's performance. In a further example, the user may participate in a fantasy sports league, with his/her team saved within the central storage location 128 of the service 122. In such an example, the server(s) 124 may compile a playlist showing video clips of the user's fantasy team players.

Another criteria for inclusion of videos by server(s) 124 in the video playlist 126 for a user may be those videos which are most popular. Popularity may be determined by overall popularity in a given geographic area at the current time. Popularity may alternatively be determined by popularity in one or more classifications or social groups to which a user belongs. Another criteria for inclusion of videos on the video playlist 126 for the user may be the videos which the user and/or the user's friends elected to view in a prior viewing session (viewing sessions are explained hereinafter).

One or more of these criteria may be applied by server(s) 124 in selecting videos for a user's video playlist 126. Each criteria may carry equal weight in compiling a play list. Alternatively, one or more of these criteria may be weighted more heavily by server(s) 124 in selecting videos for the user's video playlist. Where criteria are afforded different weights, these weights may be user selected, or they may be determined by server(s) 124 applying a set of predetermined rules. For example, express user preferences may be given the greatest weight, most popular may be given average weight, and past-viewed videos may be given the least weight. These relative weights are by example only, and may be switched around in different embodiments.

These above-described criteria may also be used by the server(s) 124 in setting the order of the video clips in the playlist. For example, those video clips which are determined to likely be of greatest interest to the user may be placed at the start of the playlist. In further embodiments, the video clips may be ordered chronologically, with the video clips from the earliest time period being placed at the start of the playlist. The most recent video clips may alternatively be placed at the start of the playlist.

Videos may be stored in the playlist 126 together with metadata associated with each video in the playlist. The metadata for a video may include a time and date the video was captured and the time and date the video is included in the playlist 126. The metadata may further include a title for the video. This title may for example come from the person who captured the video or the title may be created by others. The metadata may further include a preview sequence from the video, which may for example be the opening frames of the video, or interesting frames, referred to as highlight frames, within the video. Highlight frames may be user-designated. Alternatively, highlight frames may be automatically designated, for example by how often particular frames from a video were viewed, or shared, by others. Thus, the frame or frames that were most often viewed or shared by others may be designated as the highlight frames for that video clip. The metadata associated with video clips (such as for example which frame(s) are the highlight frames) may be updated by the server(s) 126 over time.

In step 202, one or more video playlists 126 of a user are downloaded to the user's client computing device or devices 110. In embodiments, the video playlists 126 may be downloaded during idle periods of a client computing device 110, though it may be otherwise in further embodiments.

As noted above, in operation, the highlight reel generation software application 112 may automatically generate a highlight reel from a stored playlist. The highlight reel may have the quality and choreography of a TV broadcast experience. Once the user launches the highlight reel generation software application 112, a user may initially specify which of the one or more playlists 126 of videos the user wishes to view.

Once a playlist is selected, the highlight reel generation software application 112 may begin in step 204 by automatically generating an opening video sequence to start and introduce the highlight reel of video clips. The opening video may be similar to the opening of a quality highlight TV broadcast, and may instill in the user a feeling of the user viewing a professionally choreographed television show. However, unlike a TV broadcast which requires a team of individuals to put it together, the highlight reel according to the present technology may be automatically created by the highlight reel generation software application 112.

The opening video sequence may render broadcast-style graphics that includes a show title and video previews, possibly with titling graphics, of the upcoming clips. The opening video may include an audio track of music or talk as well. The highlight reel generation software application 112 may include one or more software templates using a markup language such as for example XFW markup language, though other markup languages are possible.

The markup language templates set the overall layout, appearance and animation flow of the opening video sequence. The markup language templates can dynamically change, or swap, assets to customize the opening video sequence for a given highlight reel. Swappable assets may come from a stored stock of assets and/or from metadata associated with one or more videos in the playlist or the playlist as a whole. The highlight reel generation software application 112 can choose which assets to include in the markup language template based on the content of the video clips and from the metadata associated with the video clips. Some of the elements that may be swappable include background, midground, title field, portraits and other types of graphics as explained below. In embodiments, the highlight reel generation software application 112 examines the video clips and metadata in the playlist and makes a determination as to which assets to include in the template. At runtime of the highlight reel (or before), the template displays the opening video sequence with the selected assets. The markup language templates for the transitional video sequences and closing video sequences, described below, may function in a similar manner.

The one or more markup language templates of the highlight reel generation software application 112 for the opening video sequence may be populated with textual graphics, such as for example a user's name and other profile information. Other textual graphics such as for example a general subject matter of the video clips may be included. For example, if all of the clips have a common overarching theme (a user's fantasy team, favorite team or player, current events, etc.), a title for the playlist may be included in the metadata for the playlist and used by the markup language template(s) for the opening sequence. Other textual graphics such as the date, length of playlist, source of the playlist, etc. may be included.

The markup language template(s) may further receive the opening or highlight frames from the metadata of one some or all of the video clips for display in the opening video sequence as a preview of what is to come in the highlight reel. These may play in succession (0.5 to 1.5 seconds each, though the length of time the frames are shown may be shorter or longer than this in further embodiments). These frames may play after the textual graphics, or together with the textual graphics, for example below the textual graphics, off to the side of the textual graphics or as a background behind the textual graphics. Instead of playing in succession, the frames may be displayed all at once, for example as thumbnails below the textual graphics, off to the side of the textual graphics or as a background behind the textual graphics.

There may be a single opening video sequence for each of the user's one or more video playlists, or there may be a different opening video sequence for each of the user's multiple video playlists. The opening video sequence for a selected playlist 26 may be created in advance and stored in the central storage location, for example by a version of the highlight reel generation software 112 running on a server 124 associated with the central service 122. Alternatively, the opening video sequence for a selected playlist 126 may be created in advance and stored locally on a client computing device 110, for example by a version of the highlight reel generation software application 112 running on the client computing device 110. As a further option, the opening video sequence may be generated by the highlight reel generation software application 112 on computing device 110 at the time a playlist is selected by a user. Where generated and stored in advance, it is conceivable that a user may edit the opening video sequence to create and/or edit the content of the opening video.

After creation of the opening video sequence, the highlight reel generation software application 112 may create and display a transitional video sequence in step 206 introducing the first (and then subsequent) video clips in the highlight reel. In particular, the one or more markup language templates of the highlight reel generation software application 112 may be dedicated to a transitional video sequence for an upcoming video clip. The markup language template for the transitional video sequence may be populated with textual graphics, such as for example a title of the upcoming video clip received from the metadata associated with the upcoming video clip. Other textual graphics such as the date, countdown clock to the start of the video clip, length of the video clip, countdown clock showing the time to the next video clip, source of the video clip, etc. may be included. Other non-textual graphics may be included, such as for example team logos and/or logos from the central service 122.

The markup language template(s) for the transitional video sequence may further receive the opening or highlight frames from the metadata of the upcoming video clip as a preview of what is to come in the video clip. These one or more frames may play after the textual graphics, or together with the textual graphics, for example below the textual graphics, off to the side of the textual graphics or as a background behind the textual graphics.

In the embodiment described below, the transitional video sequence is generated at the time (just prior to) it being displayed. In further embodiments, the transitional video sequences for one or more of the video clips in the playlist may be created in advance, either by the server(s) 124 in the central service 122 or in the computing device 110. In such embodiments, the transitional video sequence(s) may be stored in the central storage location 128 or in memory 108 on the computing device 110.

The content included in the transitional video sequence may vary depending on the related video clip. For example, if the upcoming video clip focuses on a player, the transitional video sequence may provide statistics and other information for the player. A video clip may be displayed in step 208 following its associated transitional video sequence.

The user may watch the entire highlight reel as a packaged in a linear sequence. Upon completion of a video clip, the transitional video sequence for the next video clip may be generated and displayed. Alternatively, the transitional video sequence for the next video clip may be displayed to the side or below the previous video clip while the previous video clip is still playing.

Instead of viewing the entire highlight reel in linear sequence, a user is free to customize the viewing session as desired in step 212. As noted above, the computing device 110 (or computing device 120 in embodiments operating with two computing devices) may include the highlight reel interaction software application 142 which presents a user interface allowing the user to interact with the highlight reel and customize it as he/she sees fit.

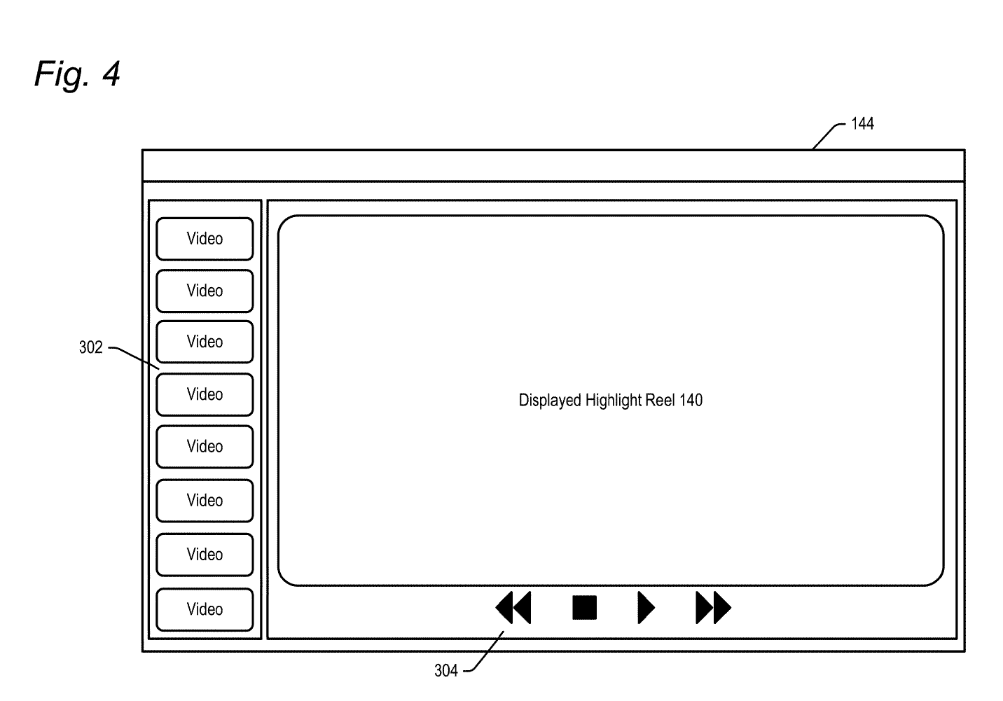

For example, FIG. 4 illustrates a user interface 144 presented by the highlight reel interaction software application 142. In embodiments including a single computing device 110, the user interface may be displayed on a display 118 associated with the single computing device 110, as shown in FIG. 4. In such embodiments, the user interface 144 may be displayed alongside (or above or below) the highlight reel 140. In embodiments such as shown in FIG. 2 including two computing devices 110, 120, the highlight reel may be displayed on display 118 associated with computing device 110, and the user interface 144 may be displayed on the second computing device 120.

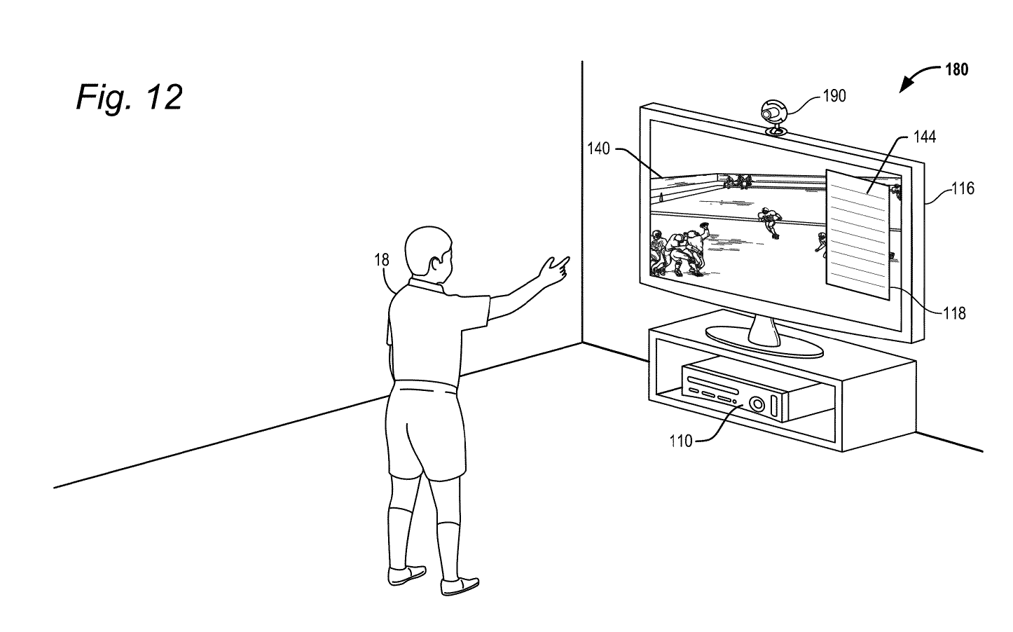

The user interface 144 may include a video guide 302 with information about each video scheduled to played in the viewing session. The information may include a title of each video clip, and possibly a description of each video clip included within the metadata of each video clip. Through interaction with the video guide 302 in a step 212, a user is free to skip one or more videos, cut a video short or jump forward or backwards in the playlist. The user interface 144 may further include soft buttons 304 allowing a user to pause, play, rewind or fast forward within a video clip. As noted above, where the computing device 110 provides a NUI system, the function of user interface 144 may instead be performed by a user with gestures and/or speech. An example of a NUI system is described in greater detail below with respect to FIG. 12.

Once a viewing list is complete, or the user has elected to end the viewing session, the application 112 may automatically generate and display a closing video sequence in step 210. The closing video sequence may be similar to the closing of a traditional broadcast television show, and may instill in the user a feeling of the user viewing a professionally choreographed television show. The closing video sequence may render broadcast-style graphics that includes any of the textual graphics and/or frames described above. It may include a further closing salutation textual graphic indicating the highlight reel is over, such as for example displaying “End,” or “Your Highlight Reel Entitled [title of highlight reel from metadata] Has Completed.” Other closing text may be used in further embodiments.

The closing video sequence may be created by one or more markup language templates of the highlight reel generation software application 112. The software templates receive assets from the metadata associated with one, some or all of the video clips in the playlist to create the closing video sequence.

There may be a single closing video sequence for each of the user's one or more video playlists, or there may be a different closing video sequence for each of the user's multiple video playlists. The closing video sequence for a selected playlist 26 may be created in advance and stored in the central storage location 128, for example by a version of the highlight reel generation software 112 running on a server 124 associated with the central service 122. Alternatively, the closing video sequence for a selected playlist 126 may be created in advance and stored locally on a client computing device 110, for example by a version of the highlight reel generation software application 112 running on the client computing device 110. As a further option, the closing video sequence may be generated by the highlight reel generation software application 112 on computing device 110 upon completion of the highlight reel. Where generated and stored in advance, it is conceivable that a user may edit the closing video sequence to create and/or edit the content of the closing video.

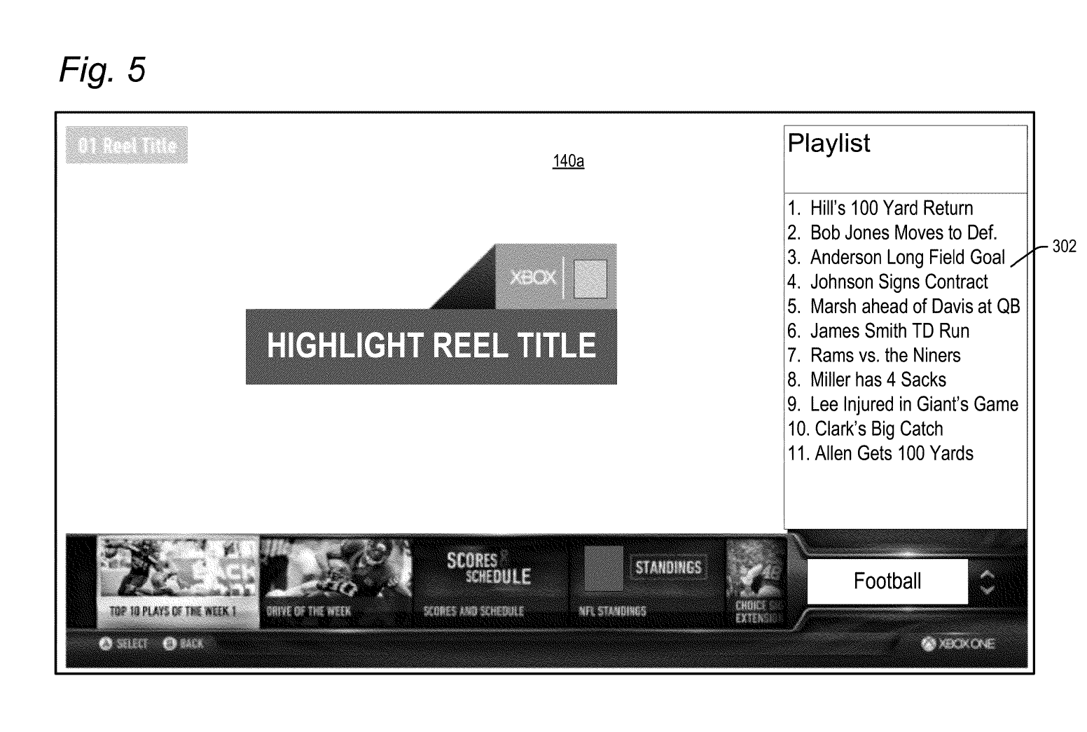

FIGS. 5-11 present images from a sample highlight reel 140 according to embodiments of the present technology. FIG. 5 illustrates an opening video sequence 140a including a title of the highlight reel. As noted above, the opening video sequence may include other graphics and images previewing what is to come in the highlight reel. The video guide 302 may display a list of titles of the videos included in the playlist. The display may include content that is unrelated to the highlight reel (such as shown along the bottom of the image of FIG. 5). This allows the user to leave the highlight reel in view of the content. In further embodiments, the display may be wholly dedicated to the highlight reel have no unrelated content.

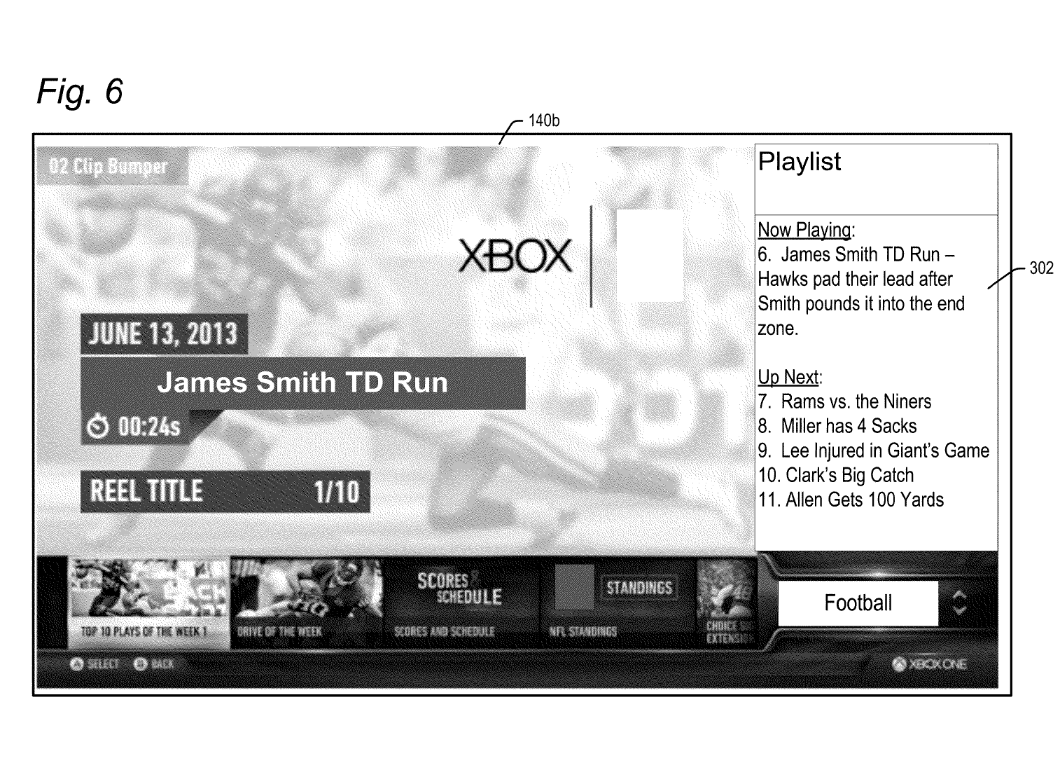

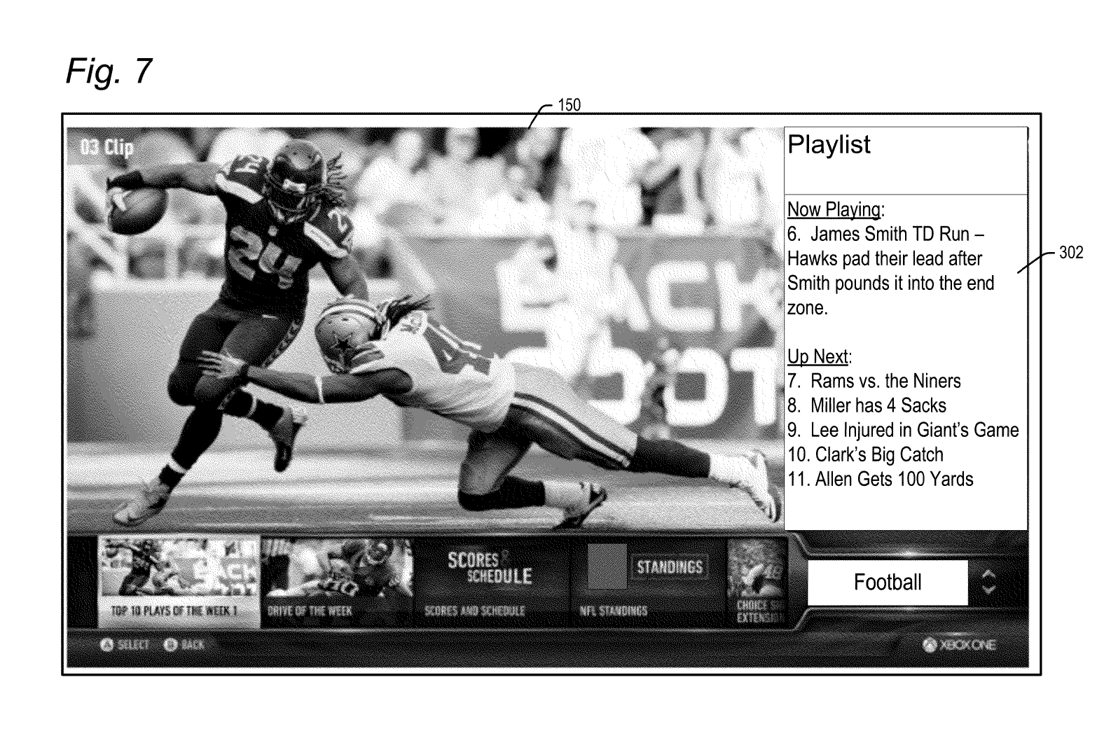

FIG. 6 illustrates a transitional video sequence 140b (also referred to as a video clip bumper or clip bumper). As indicated in the video guide 302, this is the sixth video clip in the playlist (the user either having watched the first five or skipped to the sixth video clip). As indicated, the video guide 302 indicates the currently playing video clip, and provides a description of the video clip. The video guide 302 further shows the video clips that are up next. The transitional video sequence 140b shows a title of the video clip, the date of the video clip and the run time length of the video clip. The transitional video sequence 140b also shows a frame from the video clip in the background. After the video clip is introduced by the transitional video sequence 140b, the video clip 150 may be displayed to the user as shown in FIG. 7.

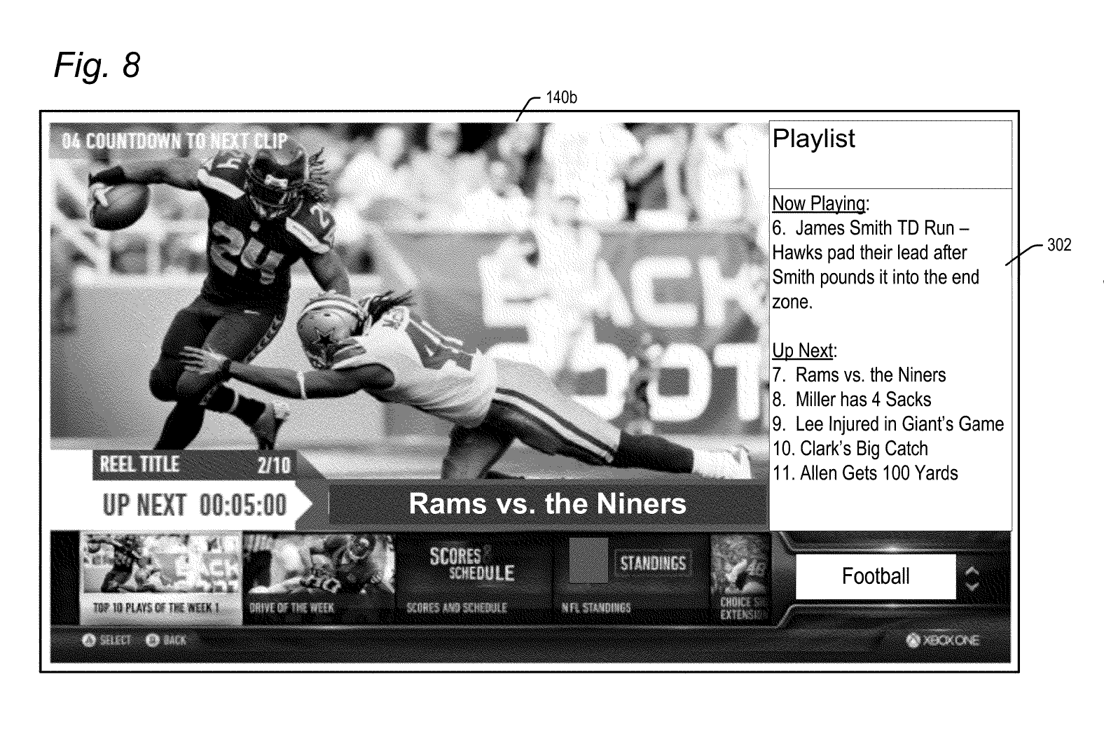

FIG. 8 illustrates a further example of a transitional video sequence 140b. In this example, the sequence 140b for the subsequent video clip begins playing before completion of the current video clip. Thus, graphics are displayed over the currently playing video clip providing transitional information regarding the next subsequent video clip. In this example, the transitional video sequence 140b gives the title of the upcoming video clip, and the time until run time until it starts.

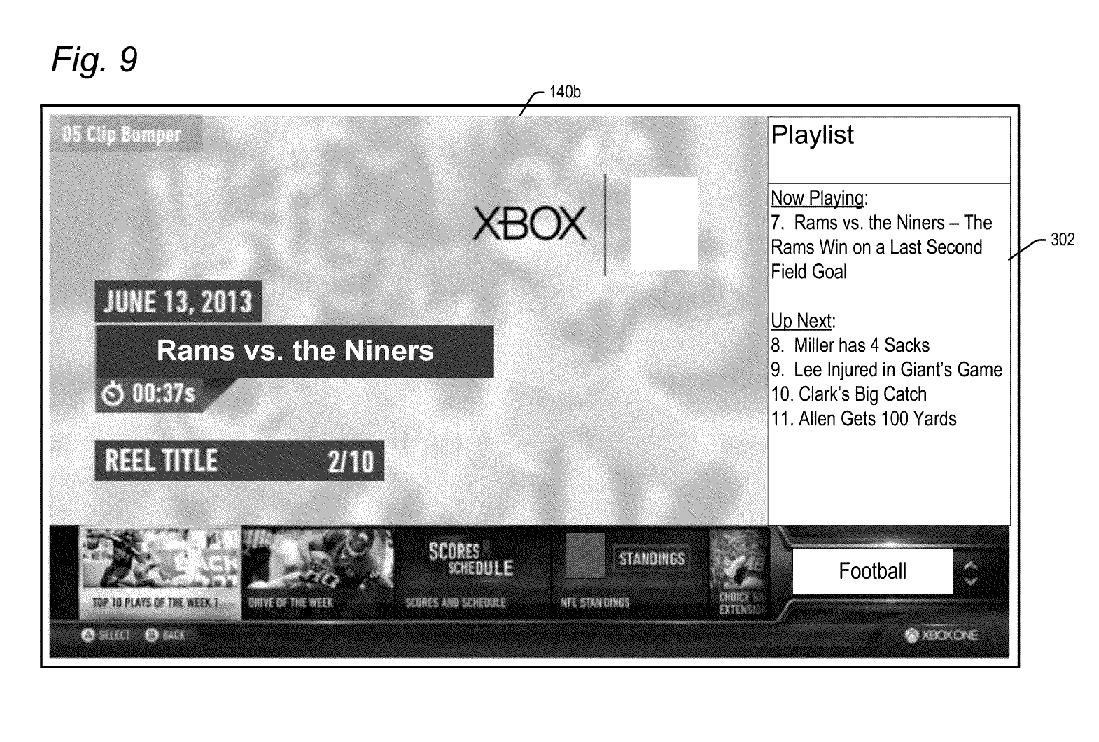

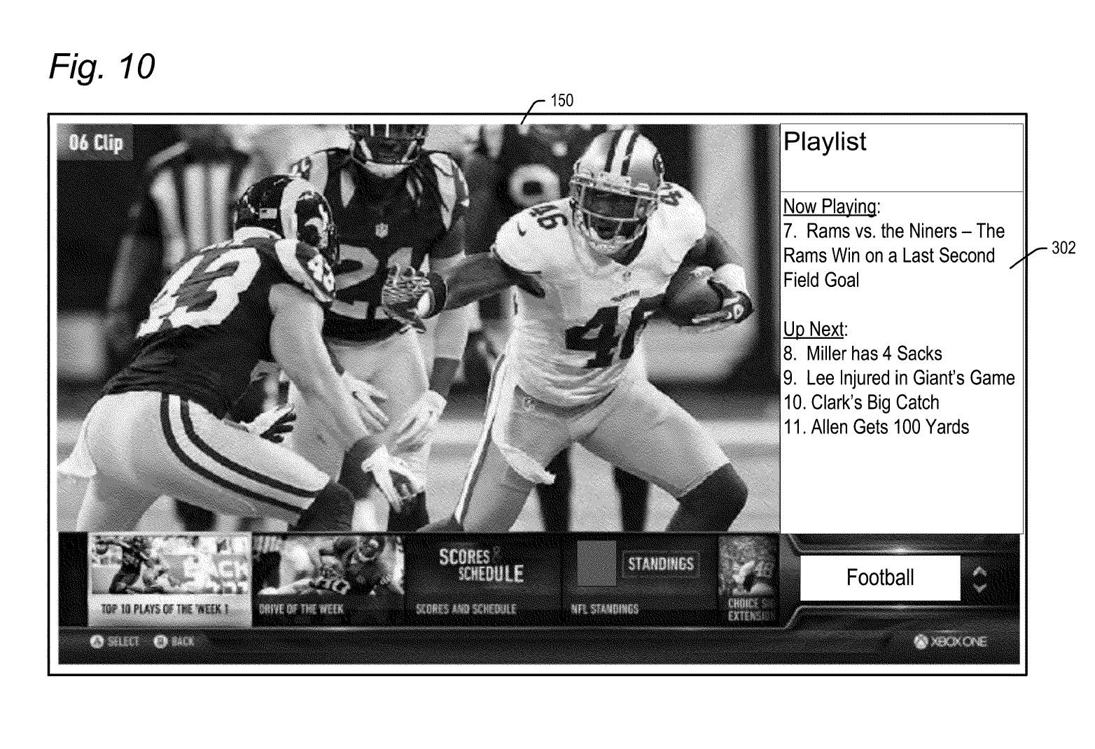

The transitional video sequence 140b shown in FIG. 8 may transition to the transitional video sequence 140b shown in FIG. 9. That is, upon completion of the sixth video clip shown in the examples of FIGS. 7 and 8, the transitional video sequence 140b shown in FIG. 9 may be displayed to introduce the seventh video clip. The transitional video clip of FIG. 9 shows a title of the video clip, the date of the video clip and the run time length of the video clip. The transitional video sequence 140b also shows a frame from the video clip in the background. The video guide 302 indicates the currently playing video clip, and provides a description of the video clip. The video guide 302 further shows the video clips that are up next. After the video clip is introduced by the transitional video sequence 140b, the video clip 150 may be displayed to the user as shown in FIG. 10.

A transitional video sequence may include both the images from FIGS. 8 and 9 so that it begins at the end of a currently-playing video clip and segues into the following video clip as shown. In further embodiments, a transitional video sequence 140b may include just a video sequence toward the end of a currently playing video to introduce the next video clip (as in FIG. 8). Alternatively, a transitional video sequence 140b may include just the video sequence after a video sequence has completed to introduce the next video clip (as in FIG. 9).

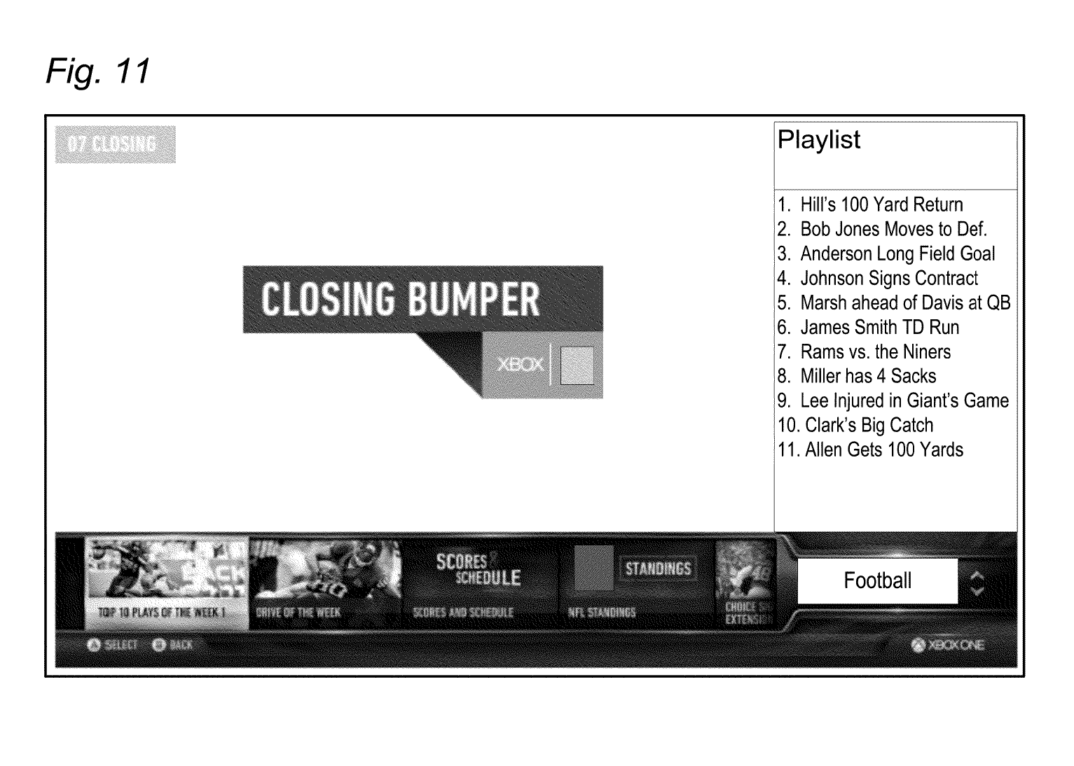

FIG. 11 illustrates an image from the closing video sequence 140c (also referred to as the closing video bumper or closing bumper) after completion of the last video clip in the highlight reel. As noted above, the closing video sequence may include the highlight reel title and/or a closing salutation. The closing video sequence 140c may further include other graphics and images from the highlight reel. The video guide 302 may display a list of titles of the videos included in the playlist. In further embodiments, the video guide 302 may be omitted from the closing video sequence 140c.

FIG. 12 illustrates an example embodiment of an NUI system 180 that can provide a natural user interface for interacting with a highlight reel 140 as described above. NUI system 180 may include the computing system 110 and A/V device 116 as described above. The user interface 144 in this embodiment may be displayed on the display 116 superimposed over (or to the top/side/bottom of) the highlight reel 140. The NUI system 180 may further include a capture device 190, which may be, for example, a camera that can visually monitor one or more users.

With the aid of capture device 190, the NUI system 180 may be used to recognize, analyze, and/or track one or more humans. For example, a user 18 may be tracked using the capture device 190 such that the gestures and/or movements of user may be captured and interpreted as interactions with the highlight reel 140 or the user interface 144. In this way, the user 18 may interact with the highlight reel interaction software application 142 executing on the computing system 110 in this embodiment.

FIG. 13 illustrates an example embodiment of a computing system that may be used to implement computing systems 110, 120. As shown in FIG. 13, the multimedia console 500 has a central processing unit (CPU) 501 having a level 1 cache 502, a level 2 cache 504, and a flash ROM 506 that is non-volatile storage. The level 1 cache 502 and a level 2 cache 504 temporarily store data and hence reduce the number of memory access cycles, thereby improving processing speed and throughput. CPU 501 may be provided having more than one core, and thus, additional level 1 and level 2 caches 502 and 504. The flash ROM 506 may store executable code that is loaded during an initial phase of a boot process when the multimedia console 500 is powered on.

A graphics processing unit (GPU) 508 and a video encoder/video codec (coder/decoder) 514 form a video processing pipeline for high speed and high resolution graphics processing. Data is carried from the graphics processing unit 508 to the video encoder/video codec 514 via a bus. The video processing pipeline outputs data to an A/V (audio/video) port 540 for transmission to a television or other display. A memory controller 510 is connected to the GPU 508 to facilitate processor access to various types of memory 512, such as, but not limited to, a RAM.

The multimedia console 500 includes an I/O controller 520, a system management controller 522, an audio processing unit 523, a network (or communication) interface 524, a first USB host controller 526, a second USB controller 528 and a front panel I/O subassembly 530 that are preferably implemented on a module 518. The USB controllers 526 and 528 serve as hosts for peripheral controllers 542(1)-542(2), a wireless adapter 548 (another example of a communication interface), and an external memory device 546 (e.g., flash memory, external CD/DVD ROM drive, removable media, etc. any of which may be non-volatile storage). The network interface 524 and/or wireless adapter 548 provide access to a network (e.g., the Internet, home network, etc.) and may be any of a wide variety of various wired or wireless adapter components including an Ethernet card, a modem, a Bluetooth module, a cable modem, and the like.

System memory 543 is provided to store application data that is loaded during the boot process. A media drive 544 is provided and may comprise a DVD/CD drive, Blu-Ray drive, hard disk drive, or other removable media drive, etc. (any of which may be non-volatile storage). The media drive 144 may be internal or external to the multimedia console 500. Application data may be accessed via the media drive 544 for execution, playback, etc. by the multimedia console 500. The media drive 544 is connected to the I/O controller 520 via a bus, such as a Serial ATA bus or other high speed connection (e.g., IEEE 1394).

The media console 500 may include a variety of computer readable media. Computer readable media can be any available tangible media that can be accessed by computer 441 and includes both volatile and nonvolatile media, removable and non-removable media. Computer readable media does not include transitory, transmitted or other modulated data signals that are not contained in a tangible media.

The system management controller 522 provides a variety of service functions related to assuring availability of the multimedia console 500. The audio processing unit 523 and an audio codec 532 form a corresponding audio processing pipeline with high fidelity and stereo processing. Audio data is carried between the audio processing unit 523 and the audio codec 532 via a communication link. The audio processing pipeline outputs data to the A/V port 540 for reproduction by an external audio user or device having audio capabilities.

The front panel I/O subassembly 530 supports the functionality of the power button 550 and the eject button 552, as well as any LEDs (light emitting diodes) or other indicators exposed on the outer surface of the multimedia console 100. A system power supply module 536 provides power to the components of the multimedia console 100. A fan 538 cools the circuitry within the multimedia console 500.

The CPU 501, GPU 508, memory controller 510, and various other components within the multimedia console 500 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 500 is powered on, application data may be loaded from the system memory 543 into memory 512 and/or caches 502, 504 and executed on the CPU 501. The application may present a graphical user interface that provides a consistent user experience when navigating to different media types available on the multimedia console 500. In operation, applications and/or other media contained within the media drive 544 may be launched or played from the media drive 544 to provide additional functionalities to the multimedia console 500.

The multimedia console 500 may be operated as a standalone system by simply connecting the system to a television or other display. In this standalone mode, the multimedia console 500 allows one or more users to interact with the system, watch movies, or listen to music. However, with the integration of broadband connectivity made available through the network interface 524 or the wireless adapter 548, the multimedia console 500 may further be operated as a participant in a larger network community. Additionally, multimedia console 500 can communicate with processing unit 4 via wireless adaptor 548.

When the multimedia console 500 is powered ON, a set amount of hardware resources are reserved for system use by the multimedia console operating system. These resources may include a reservation of memory, CPU and GPU cycle, networking bandwidth, etc. Because these resources are reserved at system boot time, the reserved resources do not exist from the application's view. In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., pop ups) are displayed by using a GPU interrupt to schedule code to render popup into an overlay. The amount of memory used for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resync is eliminated.

After multimedia console 500 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 501 at predetermined times and intervals in order to provide a consistent system resource view to the application. The scheduling is to minimize cache disruption for the gaming application running on the console.

When a concurrent system application uses audio, audio processing is scheduled asynchronously to the gaming application due to time sensitivity. A multimedia console application manager (described below) controls the gaming application audio level (e.g., mute, attenuate) when system applications are active.

Optional input devices (e.g., controllers 542(1) and 542(2)) are shared by gaming applications and system applications. The input devices are not reserved resources, but are to be switched between system applications and the gaming application such that each will have a focus of the device. The application manager preferably controls the switching of input stream, without knowing the gaming application's knowledge and a driver maintains state information regarding focus switches. Capture device 320 may define additional input devices for the console 500 via USB controller 526 or other interface. In other embodiments, computing system 312 can be implemented using other hardware architectures. No one hardware architecture is required.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the invention be defined by the claims appended hereto.

We claim:

1. A method of generating and presenting a video highlight reel, comprising:
(a) receiving a playlist of videos and metadata associated with the videos in the playlist;
(b) processing the playlist into the highlight reel by including videos from the playlist and at least one of an opening video sequence, a transitional video sequence between two videos in the playlist and a closing video sequence, the at least one opening video sequence, transitional video sequence and closing video sequence automatically and dynamically created using the metadata associated with the videos in the playlist; and
(c) displaying the highlight reel.

2. The method of claim 1, wherein the step of processing the playlist into the highlight reel comprises the step of processing at least one of the opening video sequence and transitional video sequence to include a title provided within the metadata.

3. The method of claim 1, wherein the step of processing the playlist into the highlight reel comprises the step of processing at least one of the opening video sequence and transitional video sequence to include graphics provided within the metadata.

4. The method of claim 1, wherein the step of processing the playlist into the highlight reel comprises the step of processing at least one of the opening video sequence and transitional video sequence to include one or more frames from the videos in the playlist.

5. The method of claim 4, wherein the one or more frames from the videos in the playlist are the opening frames from one or more videos in the playlist.

6. The method of claim 4, wherein the one or more frames from the videos in the playlist are the highlight frames from one or more videos in the playlist.

7. The method of claim 1, further comprising the step of displaying a user interface allowing a user to customize an order with which videos from the highlight reel are displayed.

8. The method of claim 1, wherein said step (b) comprises the step of processing the playlist into the highlight reel by including videos from the playlist and each of the opening video sequence, the transitional video sequence and the closing video sequence.

9. The method of claim 1, wherein said step (a) comprises the step of receiving a sports-related playlist and said step (b) comprises the step of processing the playlist into a sports-related highlight reel.

10. A system for generating and presenting a customized video highlight reel, comprising:
a computing device, comprising:
a processor receiving a customized playlist of videos and metadata associated with the videos in the playlist, the playlist customized for a user based on at least one of the user's profile, expressed preferences and popularity of the videos, the processor processing the playlist into the highlight reel by including videos from the playlist and at least one of an opening video sequence, a transitional video sequence between two videos in the playlist and a closing video sequence, the at least one opening video sequence, transitional video sequence and closing video sequence automatically and dynamically created using the metadata associated with the videos in the playlist; and
a display for displaying the highlight reel.

11. The system of claim 10, further comprising a user interface allowing a user to interact with the highlight reel.

12. The system of claim 11, the computing device comprising a first computing device, the system further comprising a second computing device, the user interface displayed on the second computing device.

13. The system of claim 11, the user interface comprising a natural user interface allowing a user to interact with the highlight reel via at least one of gestures and speech.

14. The system of claim 10, further comprising a server within a central service, remote from the computing device, the server compiling videos into the playlist based on at least one of a user profile stored in the central service, preferences received from the user and a popularity of videos.

15. The system of claim 14, the server further setting an order of videos in the playlist based on at least one of the user profile, preferences received from the user and the popularity of videos.

16. The system of claim 14, wherein the server compiles a sports-related highlight real where the videos included in the playlist relate to one of current events in sports, the user's favorite sports teams and the user's fantasy league sports team.

17. A computer-readable storage medium for programing a processor to perform a method of generating and presenting a video highlight reel, the method comprising:
(a) receiving a playlist of videos and metadata associated with the videos in the playlist, the playlist customized for a user as to selection and ordering of videos in the playlist based on at least one or the user's profile, the user's preferences and the popularity of the videos in the playlist;
(b) processing the playlist into the highlight reel by including videos from the playlist and at least one of an opening video sequence, a transitional video sequence between two videos in the playlist and a closing video sequence, the at least one opening video sequence, transitional video sequence and closing video sequence automatically and dynamically created using the metadata associated with the videos in the playlist;
(c) generating a video guide including titles of the videos in the highlight reel and a description of the videos in the highlight reel, the titles and descriptions generated using the metadata associated with the videos in the playlist; and
(d) displaying videos from the highlight reel and a user interface including the video guide, the videos displayed in a user-defined order based on a received interaction with the video guide.

18. The computer-readable storage medium of claim 17, wherein the step of processing the playlist into the highlight reel comprises the step of processing at least one of the opening video sequence and transitional video sequence to include at least one of a title provided within the metadata, graphics provided within the metadata and a runtime length of the videos provided within the metadata.

19. The computer-readable storage medium of claim 17, wherein the step of processing the playlist into the highlight reel comprises the step of processing at least one of the opening video sequence and transitional video sequence to include one or more frames from the videos in the playlist.

20. The computer-readable storage medium of claim 17, wherein the step of processing the playlist into the highlight reel comprises the step of processing the transitional video sequence to include a time remaining until the next video in the playlist is played.
